(19) United States
(12) Patent Application Publication
(10) Pub. No.: US 2009/0058639 A1
(43) Pub. Date: Mar. 5, 2009

(54) SENSOR NODE AND SENSOR NETWORK SYSTEM

(76) Inventors: Takeshi TANAKA, Akishima (JP); Shunzo YAMASHITA, Musashino (JP); Hiroyuki KURIYAMA, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/181,853

(22) Filed: Jul. 29, 2008

(30) Foreign Application Priority Data
Sep. 5, 2007 (JP) JP2007-229655

(51) Int. Cl. G08B 1/08

(52) U.S. Cl. 340/539.22

(57) ABSTRACT

Provided are a sensor node that changes and processes various applications in accordance with the change of networks and wirelessly transmits the data obtained from devices such as the scales to a specified monitor PC in the same manner as the sensing data and a sensor network system having the sensor node. A sensor node according to the present invention is provided with a sensor for measuring biological information and a wireless communication unit for transmitting data, and the sensor node further comprises: a plurality of intrinsic programs that drive the wireless communication unit to communicate with different wireless devices; a common program that drives the sensor to make a measurement without being dependent on the intrinsic programs; and a nonvolatile memory unit that records the data.

### CROSS-REFERENCE TO RELATED APPLICATION

The present application claims priority from Japanese Patent Application No. JP 2007-229655 filed on Sep. 5, 2007, the content of which is hereby incorporated by reference into this application.

### TECHNICAL FIELD OF THE INVENTION

The present invention relates to a technology for controlling wireless communication and a sensor used for a small mobile sensor terminal with a wireless communication function.

### BACKGROUND OF THE INVENTION

In “Wireless Sensor Network MOTE-2007” catalog, Crossbow Co., Ltd., “searched on May 1, 2007”, Internet <URL: http://www.xbow.jp/mote2dot.pdf> (Non-Patent Document 1), a small sensor node called “Mote” is introduced. This sensor node operates for a long time with a small built-in battery by means of an intermittent operation in which the sensor node is activated only at the timings of performing the sensing and wireless communication and is otherwise turned off to reduce the power consumption, and further it has a small size of 3 cm and a person can easily put on it.

In addition, in “IEEE Standards 802.15.4” specifications, IEEE, “searched on Aug. 20, 2007”, Internet <URL: http://standards.ieee.org/getieee802/download/802.15.4-2003.pdf> (Non-Patent Document 2), a wireless communication standard used in a wireless terminal such as a sensor node is disclosed. Instead of restricting the transmission speed and the communications distance, the power consumption is low in this wireless communication standard. Japanese Patent Application Laid-Open Publication No. 2007-184754 (Patent Document 1) discloses a method in which, when a mobile sensor node is outside the communication range, the data of the sensor is saved into a built-in memory, and the saved data is transmitted at a time when the mobile sensor node moves in the communication range.

Japanese Patent Application Laid-Open Publication No. 2005-020112 (Patent Document 2) discloses a method in which, in such a mobile wireless device, plural pieces of network information are recorded in advance in a nonvolatile memory of the wireless terminal and determination is manually or automatically made to select the network information after movement, and in this manner, a process to access networks can be omitted and the changes of the networks can be facilitated.

Japanese Patent Application Laid-Open Publication No. 2006-109076 (Patent Document 3) discloses a control method in which not only networks are changed in response to an external trigger by a button or power supply and others, but also an operation is performed in accordance with a preset arbitrary program depending on the destination to which the network is changed.

Japanese Patent Application Laid-Open Publication No. 2005-079896 (Patent Document 4) discloses a network device in which information of an original network is recorded in a memory when networks are changed, and is returned to the original network automatically after communications with a new destination are attempted.

Japanese Patent Application Laid-Open No. 2006-101416 (Patent Document 5) discloses the same technologies as those in Patent Documents 3 and 4.

### SUMMARY OF THE INVENTION

In recent years, small sensor terminals with a wireless communication function (sensor nodes) in which a battery is built-in have been developed. The sensor nodes are set up in buildings outdoors and indoors and are used for the measurement of environmental information such as temperature, humidity and the like. Furthermore, because the downsizing thereof has been advanced, a person can put on the sensor node without any load in everyday life, and the sensor node is applied to the detection of the movement of a person or the whereabouts of a person.

For example, in the Non-Patent Document 1, a small sensor node called “Mote” is introduced. This sensor node operates for a long time with a small built-in battery by means of an intermittent operation in which the sensor node is activated only at the timings of performing the sensing and wireless communication and is otherwise turned off to reduce the power consumption, and further it has a small size of 3 cm and a person can easily put on it.

If a person puts on this sensor node to always measure and record the movement of the person with an acceleration sensor or the like, the states of movement such as walking and the postures in everyday life can be monitored. In order to establish a sensor net system to monitor the health condition of the user by applying this, typically, the sensor makes the measurements (sensing) several ten times per second. In addition, in order to accumulate and analyze this sensing data, typically, the sensing data is transmitted to a base station (gateway) connected to a personal computer (PC) of the user, and collected therein as a basic operation.

In a wireless terminal such as the sensor node, for example, as described in IEEE 802.15.4 (Non-Patent Document 2), instead of restricting the transmission speed and the communications distance, a wireless communication standard with low power consumption is used. Since the communication distance of IEEE 802.15.4 is typically about 50 meters, in the case where a person puts on a sensor node, it is easily supposed that the person gets away from the wireless communication range of the network which one base station manages. On this account, as a structure to support the movement between a plurality of base stations, the processes called association (participation) and disassociation (separation) are prescribed. The process of association consists of the search of the network, the transmission of the association request, the reception of the response and others. In the response of the association, 2-byte ShortAddress is assigned from the base station to the sensor node. Different from the 8-byte MacAddress unique to all the devices assigned at the time of manufacture, the ShortAddress is an ID unique only in the network, and the ShortAddress is added to the packet to be transmitted and is used for the identification of the transmission source. Herein, by adding the ShortAddress, in comparison with the case of adding the MacAddress, the data capacity to be transmitted can be reduced, and the power consumption necessary for the transmission can be reduced. By this means, even when a person moves, the wireless data collection can be realized.

On the other hand, weight or blood pressure, etc. that cannot be measured by the sensor node mentioned above are indispensable to know the health condition. In order to continue recording these values in everyday life, it is desired that measurement machine and exercise machine used at home or in the places including the hospital, a sports gym and others have a wireless communication function and the measurement data can be easily taken in PCs for monitoring. For its achievement, there is a method in which the applications to communicate are changed in conformity to a wireless device in the network at the same time when networks are temporarily changed on the sensor node mentioned above.

However, when the association resulting from the change of the networks is repeated frequently, the process of wireless transmission and reception is necessary every time and the power is excessively consumed, and the battery life is shortened. In wireless LAN (IEEE 802.11), by the change to the network information recorded beforehand in a memory by the method disclosed in Patent Document 2, the process of the association becomes unnecessary, and the power consumption during this period can be reduced.

However, as a first problem, even if networks can be changed by the method mentioned above, the data received in various applications of the sensor node cannot be collected to a specified monitor PC like the case of the sensing. For example, by the method disclosed in the Patent Document 2 and the Patent Document 4, it is possible to change networks and receive measurement data from devices such as the scales. However, it is impossible to transmit the measurement data to a monitor PC together with the data of the built-in sensor. Although the Patent Document 1 discloses a method of saving data in a built-in memory, the determination whether to save the data is made by whether Ack returns at the time of the transmission, and therefore, if the wireless protocol of IEEE 802.15.4 is used, even the data to be transmitted to a monitor PC is saved only when a partner base station fails in the reception during the network change.

On the other hand, as a second problem, if a plurality of other applications are added to the sensor node whose basic operation is the sensing, the sensing data cannot be collected during the process of the application other than the sensing. For example, when a person with a sensor node uses a sports gym and the like, data during exercise sensed by the sensor node are important. At the same time, if the exercise machines (for example, weight training machine, running machine, and the like) have a wireless communication function, the function can be utilized for the transmission of individual data such as exercise strength or the usage history. In this situation, if the applications of the sensor node are changed in order to make communications by changing networks, the sensing data cannot be collected, and the activity state of the user at that time cannot be known later.

Therefore, it is necessary that the sensing data are continuously collected even when the applications are changed with the change of the networks. In the Patent Document 2 and the Patent Document 3, the method of starting the process of the applications designated in advance with the change of the networks is disclosed, but the method of continuing the sensing process in parallel to that regardless of the change of the networks is not disclosed.

The present invention has been made in consideration of the above problems in the prior art, and accordingly, an object of the present invention is to provide a sensor node that changes and processes various applications with the change of the networks, and wirelessly transmits the data provided from devices such as the scales to a specified monitor PC in the same manner as the sensing data. Furthermore, another object of the present invention is to precisely process the sensing at a constant time cycle and collect continuous sensing data later even in the case where networks and applications are changed.

The typical one of the inventions disclosed in this application will be briefly described as follows. That is, a sensor node according to the present invention has a sensor for measuring biological information and a wireless communication unit for transmitting data, and the sensor node further comprises: a plurality of intrinsic programs that drive the wireless communication unit to communicate with different wireless devices; a common program that drives the sensor to make a measurement without being dependent on the intrinsic programs; and a nonvolatile memory unit that records the data.

According to the present invention, even when a user having a sensor node moves and communicates with a plurality of wireless devices by changing networks, by collectively transmitting the data recorded in a storage after returning to the original network (network to which the data of the sensor is to be transmitted), all the data can be collected en bloc by a specified monitor PC.

### BRIEF DESCRIPTIONS OF THE DRAWINGS

FIG. 1 is a block diagram showing a sensor node according to an embodiment of the present invention;

FIG. 2 is a flow chart of an entire process in the sensor node according to the embodiment of the present invention;

FIG. 3 is a diagram showing a configuration of the data recorded in a RAM in the sensor node according to the embodiment of the present invention;

FIG. 4 is a diagram showing a configuration of the data recorded in a storage in the sensor node according to the embodiment of the present invention;

FIG. 5 is a flow chart for describing a sensing process at the step 101 of FIG. 2 in detail in the sensor node according to the embodiment of the present invention;

FIG. 6 is a flow chart for describing processes of first and second applications at the step 102 of FIG. 2 in detail in the sensor node according to the embodiment of the present invention;

FIG. 7 is a flow chart for describing a process of a first application at the step 120 of FIG. 2 in detail in the sensor node according to the embodiment of the present invention;

FIG. 8 is a flow chart for describing an unsent data retransmission process at the step 505 of FIG. 6 in detail in the sensor node according to the embodiment of the present invention;

FIG. 9 is a diagram showing an operation in which a user checks weight data received by the sensor node according to the embodiment of the present invention and selects whether to record the weight data;

FIG. 10 is a diagram showing an operation in which a user measures weight data again by the sensor node according to the embodiment of the present invention and selects whether to retransmit the weight data by the sensor node;

FIG. 11 is a flow chart for describing a storage recording process at the step 104 of FIG. 2 in detail in the sensor node according to the embodiment of the present invention;

FIG. 12 is a block diagram showing a sensor network system according to an embodiment of the present invention;

FIG. 13 is a diagram showing a state where a user of the sensor node moves, measures the weight with the scales connected to a gateway, and receives the weight data by changing the networks of the sensor node in the sensor network system according to the embodiment of the present invention;

FIG. 14 is a diagram showing a state where the sensor node returns to the original network from the network of FIG. 13 and transmits sensing data and weight data in a neighborhood of a monitor PC connected to the gateway in the sensor network system according to the embodiment of the present invention;

FIG. 15 is a diagram showing a state where there are a plurality of networks around the sensor node in the sensor network system according to the embodiment of the present invention;

FIG. 16 is a diagram showing network information in a RAM after the network search in FIG. 13 by the sensor node in the sensor network system according to the embodiment of the present invention;

FIG. 17 is a diagram showing means by which a user operates a sensor node and selects one application from a plurality of selectable applications in the sensor network system according to the embodiment of the present invention;

FIG. 18 is a diagram showing a weight history display function in the application of the sensor node in the sensor network system according to the embodiment of the present invention; and

FIG. 19 is a diagram showing a graph display function of weight history in the application of the sensor node in the sensor network system according to the embodiment of the present invention.

### DESCRIPTIONS OF THE PREFERRED EMBODIMENTS

In the present invention, in a sensor node including a sensor that measures biological information, a wireless communication unit (RF) that wirelessly transmits and receives the data of the sensor, a nonvolatile storage medium (storage) that stores the data of the sensor and the data obtained from devices such as the scales and the like, and a microcomputer that controls the sensor and the wireless communication unit, the microcomputer starts the measurement of the sensor at a constant time cycle independently from the process of the individual applications, and records all the measured data in the storage.

Furthermore, in response to the change of the networks to which the wireless communication unit communicates, the plurality of applications are changed and processed by the microcomputer, and the data measured by the sensor and the data generated by the process of the applications are once recorded in the storage and then transmitted to the specified network after the changing to the network.

In addition, a value (flag) to distinguish whether the data is unsent is attached to the data of the applications and the data measured by the sensor to be recorded in the storage, and only the unsent data is read from the storage and retransmitted later by the wireless communication unit.

Hereinafter, embodiments according to the present invention will be described in detail with reference to the attached drawings.

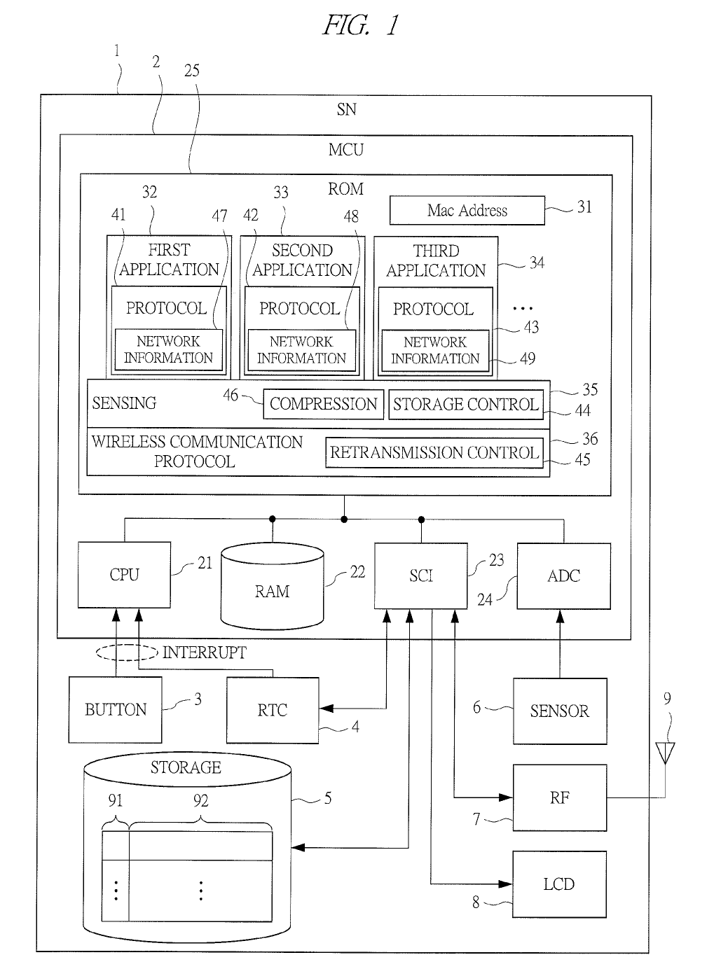

FIG. 1 shows a first embodiment and is a block diagram of a sensor node to which the present invention is applied. In FIG. 1, in order to solve the first and second problems, software to be processed by a microcomputer is separately configured into a dependent region that is dependent on individual applications and a common region that is not dependent. In particular, the common region includes a sensing program and a wireless communication protocol so that the measurement by a sensor and wireless communications can be always made independently from the process of the application dependent region. Further, in order to always record the data of each application and the sensing data in the storage, the storage control program is included in this sensing program. In addition, in order to easily change networks, the applications of an intrinsic portion have individually corresponding network information. Details thereof will be described below.

The sensor node 1 includes a wireless communication unit (RF) 7 provided with an antenna 9 for communicating with a gateway (base station), a sensor 6, a microcomputer 2 controlling the sensor 6 and the wireless communication unit 7, a real time clock (RTC) 4 functioning as a timer to trigger the microcomputer 2 at a fixed interval, a storage 5 as a nonvolatile recording medium, an LCD 8 displaying characters, waveforms and graphs, and a plurality of buttons 3 that enable to trigger the microcomputer 2.

When the storage 5 is, for example, a flash memory, the rewriting in this storage 5 can be made only in units of a certain capacity of several tens of bytes to several hundreds of bytes. The minimum unit of this rewriting is referred to as a page, and the identification number to show the position thereof is referred to as a page number.

The microcomputer 2 includes a CPU 21 which executes computation processing, a ROM 25 which records programs to be executed in the CPU 21, a RAM 22 which records data and others, an A/D converter 24 which converts analog signals output from the sensor 6 into digital signals, and a serial communication interface (SCI) 23 which performs signal transmission and reception of serial signals to and from the real time clock 4, the storage 5, the wireless communication unit 7 and the LCD 8.

In the ROM 25, a wireless communication protocol 36 to control the wireless communication unit 7, a sensing program 35 that controls the A/D converter 24 and records the output values of the sensor 6 to the RAM 22 and the storage 5, applications 32 to 34 that communicate with other wireless devices and read out and record the data from and to the RAM 22 and the storage 5, and a MacAddress 31 are recorded in advance. To the MacAddress 31, the value that does not overlap with other sensor nodes is assigned in advance, and the value is not changed once it has been recorded.

The applications 32 to 34 have protocols 41 to 43 that are communication means in their corresponding networks, and the protocols 41 to 43 have network information 47 to 49 that are necessary for the communications in the corresponding networks.

In the first embodiment, the application 32 is a first application that transmits the sensing data to a PC and monitors the health condition, the application 33 is a second application that receives and collects measurement data from the scales having the wireless communication function, and the application 34 is a third application that receives and collects exercise data from a training machine having the wireless communication function in a sports gym. In the sensor node 1, the application 32 is usually selected and operated, and can be changed to the applications 33 and 34 when a button 3 is pushed by the user as a trigger. Furthermore, when the process of the applications 33 and 34 is completed, the application returns to the application 32 again. For example, in a condition where the application 32 is selected, and furthermore, there are networks corresponding to network information 48 and 49 in the circumference, networks can be changed.

However, if the association of the above-mentioned IEEE 802.15.4 is used when networks are changed, the problem of unnecessary increase in power consumption occurs. Typically, the process time on a time scale of seconds is required, and when this process is carried out around 5 times in one hour, the power consumption increases by about 10% per an hour.

In order to solve the problem in this network change, the network information of the applications 32 to 34 in the ROM 25 is read out, and the network information is changed in the RAM 22. In this case, the process time is typically on the time scale of milliseconds, and becomes about 1/1000 in comparison with the case of the association mentioned above. Therefore, the power consumption required by the network change can be decreased to a negligible level.

In order to solve the first problem, the sensing program 35 is characterized by having a storage control program 44 that records the sensing data and the data of the applications 33 and 34 to the storage without fail. In the storage control program 44, the data obtained by the processes of the applications 33 and 34 and the data measured by the process of the sensing program 35 are once recorded in the storage 5 and are transmitted to the specified monitor PC. Therefore, different from the method disclosed in the Patent Document 1, the storage 5 is managed by the flags attached to all the packets. The flag shows whether the packet has been already transmitted to the monitor PC or not at the time of the recording to the storage 5. Further, when there are a plurality of applications having different transmission destinations, flags are attached to each of the applications and managed. For example, even if there are monitor PCs at home and in a working place, the same data can be collected and monitored in both sides.

In addition, the time necessary for the recording process of the storage control program 44 is typically about 10 milliseconds per one process when the capacity of one page of the storage 5 is, for example, 1 Kbyte and the data transmission speed is, for example, 1 Mbps (Megabit/second). This is shorter than the interrupt cycle of 50 milliseconds mentioned above, and the cycle necessary for recording one page is typically around one time every 30 seconds when the 3-axis acceleration (each 1 byte) is to be measured.

Therefore, the storage control program 44 can surely record the data of the sensing program 35 and the applications 33 and 34 to the storage 5 without delaying other processes.

Alternatively, the sensing program 35 can use a compression program 46 that uses a well-known compression method to reduce the capacity of sensing data to be recorded in the storage 5. For example, the movement of a person is measured with a 3-axis acceleration sensor (each 1 byte) every 50 milliseconds, and the data is compressed and recorded. In this case, data volume per day becomes about 5 MB by 3 (bytes)×20 (sample/second)×60 (seconds)×60 (minutes)×24 (hours). When it is compressed by the process of a microcomputer available at low cost, in the case of acceleration data of the movement of the person, it can be typically compressed to about ⅓ by the process for 5 milliseconds or shorter. Accordingly, since the data volume becomes about 1.7 MB per day, data of one week or more can be recorded with a 16 MB flash memory available at low cost.

Furthermore, in order to solve the first problem, the wireless communication protocol 36 is characterized by including a retransmission control program 45 that reads and transmits unsent data recorded in the storage 5 and the RAM 22.

Upon reception of a communication request from the sensing program 35 and the applications 32 to 34, the wireless communication protocol 36 transmits the data of the designated packet form to the gateway in the network in communication, and receives data from the gateway.

The retransmission control program 45 sequentially reads out only the flags recorded in the storage 5, and thereby can find the past unsent data. However, even if a retransmission is successfully completed with the reading by the above method, since the deletion and rewriting can be made only in units of page in the storage 5, the flag alone cannot be rewritten into already transmitted one. In other words, there is a possibility that the same data is transmitted many times. Therefore, a page position 72 that is read last in the page whose data transmission is completed is stored in the RAM 22, and this page position 72 is set to the next reading position. In this manner, the data of the storage 5 can be read and retransmitted without repetition.

For example, the time necessary for data reading and transmission (100 bytes) from the storage 5 in the method mentioned above is typically about 8 milliseconds in IEEE 802.15.4. More specifically, the retransmission control program 45 can transmit data of 10 Kbytes or more in 1 second without giving any influences on the processes of the sensing program 35 and the application 32. Therefore, all of the acceleration data of one week recorded in the flash memory can be typically transmitted wirelessly within 20 minutes.

Therefore, even in the state where the applications 33 and 34 are not selected, by the retransmission control program 45 called and executed by the application 32, the data of the applications 33 and 34 recorded in the RAM 22 and the storage 5 can be collected by the monitor PC in the same manner as the sensing data.

In order to solve the second problem, the applications 32 to 34 are characterized by temporarily stopping the process and starting the process of the sensing program 35 when an interrupt of the real time clock 4 which is a trigger to start the sensing program 35 occurs. The sensing program 35 starts the measurement of the sensor 6 with the interrupt from the real time clock 4 generated at a fixed time cycle as a trigger, and records the measurement data in the RAM 22. At this time, when the interrupt cycle of the real time clock 4 is set to, for example, 50 milliseconds necessary for the measurement of health condition (for example, pulse and walk count) of the person as mentioned above, the time necessary for the sensing program to A/D convert the output value of the sensor 6 and take it in the RAM 22 is shorter than 1 millisecond. Therefore, the falling rate of the processing speed of the applications 32 to 34 is 2% or less even if the temporary stop occurs during the process of the sensing program 35. Although the interrupt is prohibited during the process of the sensing program 35, the influence on the processing of the applications 32 to 34 can be ignored because the process time of the sensing program 35 is sufficiently short relative to the interrupt cycle. In other words, since the process of the sensing program 35 can be executed substantially in priority to the applications 32 to 34, the measurement data of the sensor 6 can be certainly recorded at a fixed time cycle without being influenced by the changes of the applications 32 to 34.

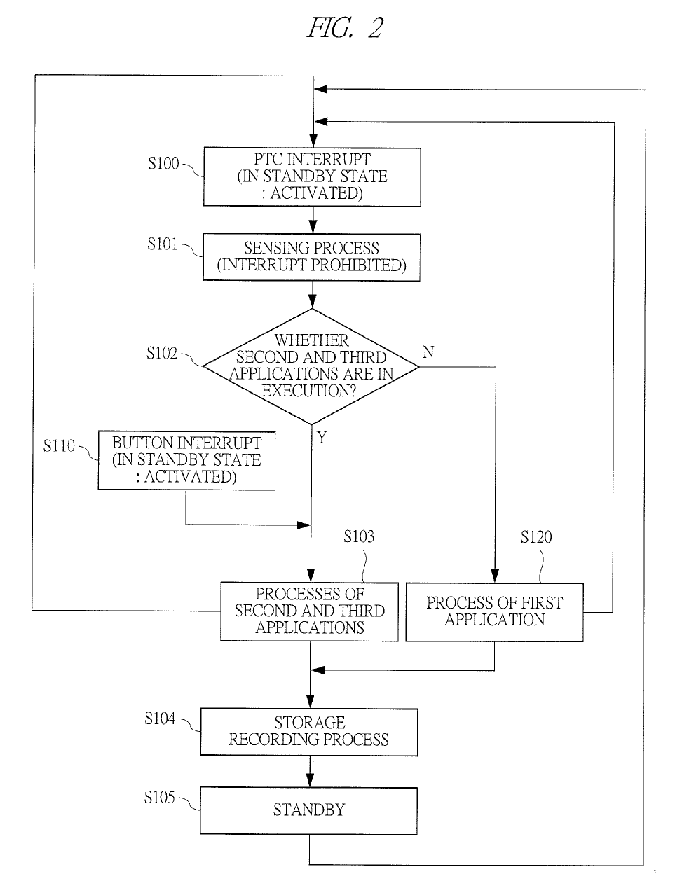

FIG. 2 shows a flow chart of a characteristic process flow in the sensor node 1 mentioned above.

In particular, in order to solve the problem 1, a storage recording process (step 104) is always performed after the process of the first to third applications (steps 103 and 120). Further, in order to solve the problem 2, the processes (steps 103 and 120) of the applications are temporarily stopped by interrupt and the process of sensing (step 101) is started, and the application in course of execution is detected (step 102) and restarted. In this manner, while substantially giving a priority to the sensing process (step 101), other applications (steps 103 and 120) can be processed at the same time.

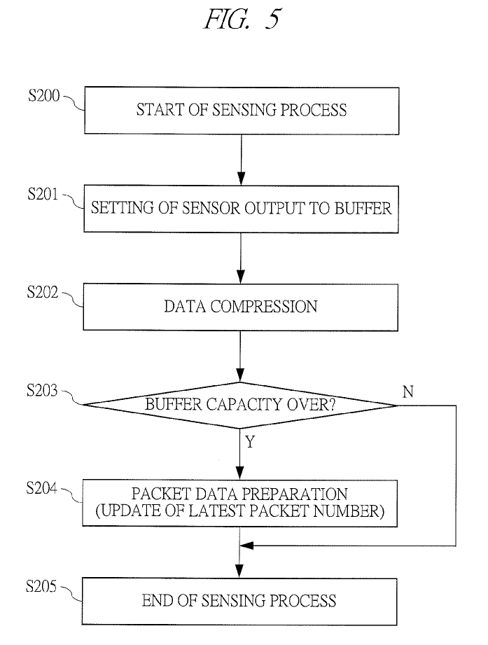

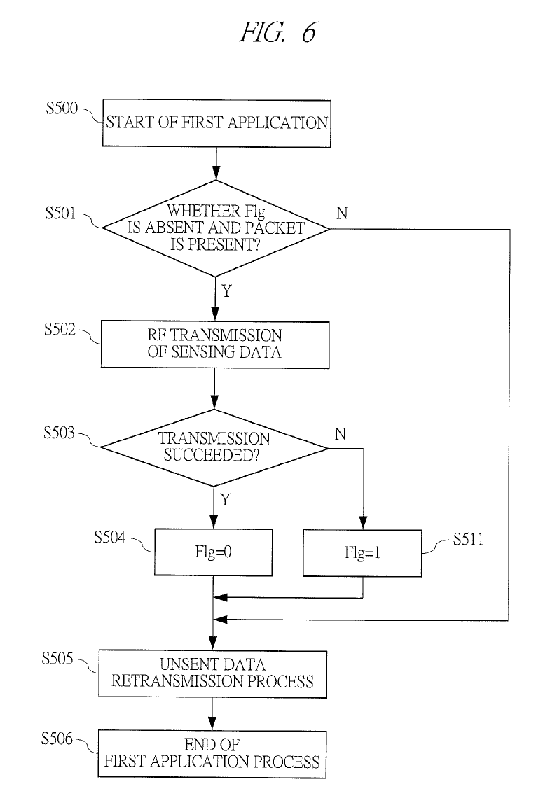

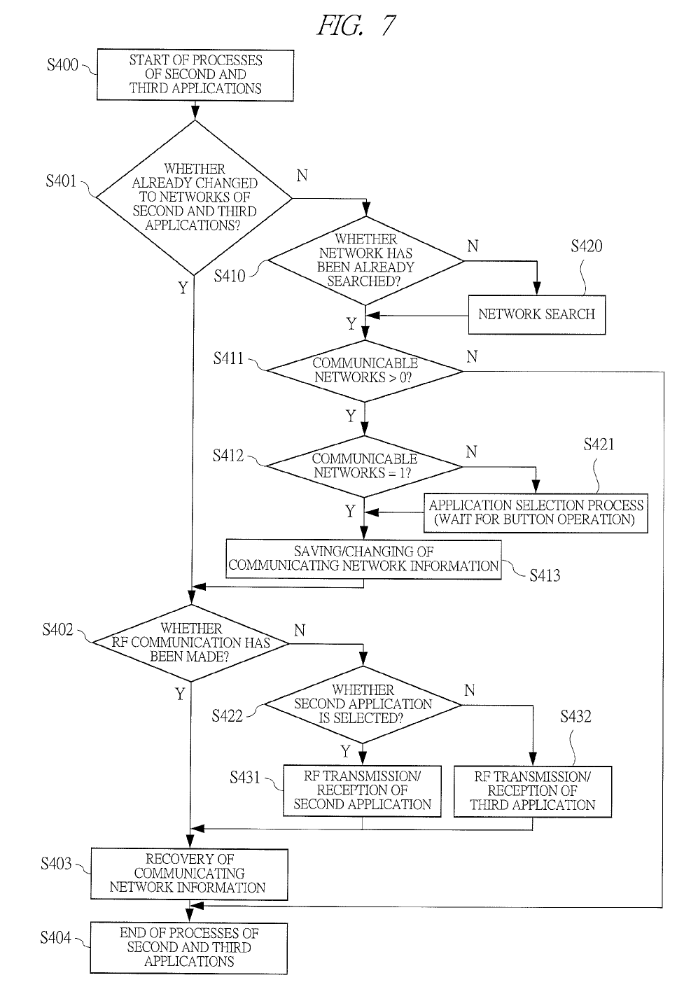

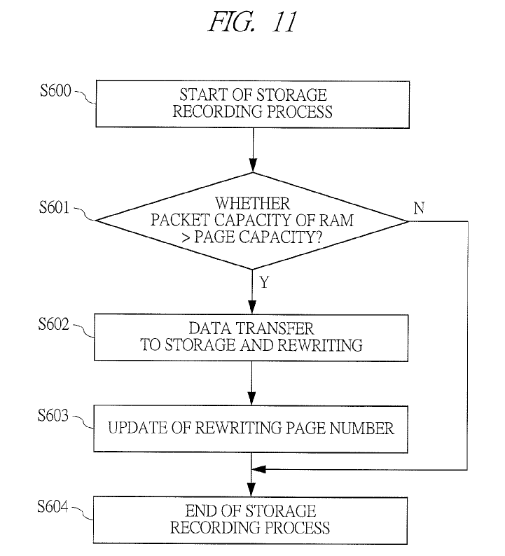

The details of the step 101 are shown in FIG. 5, the details of the step 103 are shown in FIG. 7, the details of the step 120 are shown in FIG. 6, and the details of the step 104 are shown in FIG. 11. Each of the processes will be described below.

The sensor node 1 reduces the power consumption by the intermittent operation in which the sensor node is activated only when it is necessary. Therefore, at the step 100, at the time of an interrupt of the real time clock 4, the sensor node 1 is activated if the microcomputer 2 is in a standby mode to reduce the power consumption. Further, at the step 105 that is the last process, the microcomputer 2 of the sensor node 1 is switched to a standby mode. In this manner, it is possible to reduce the power consumption from the step 105 until an interrupt occurs.

In addition, by the interrupt of the button 3 at the step 110, the process of the applications 33 and 34 shown in the step 103 is started. At this moment, if the microcomputer 2 is in a standby mode like the step 100, the sensor node 1 is activated. By this means, when the user wants to change networks and applications, it is possible to start the change processing immediately just by pushing the button 3.

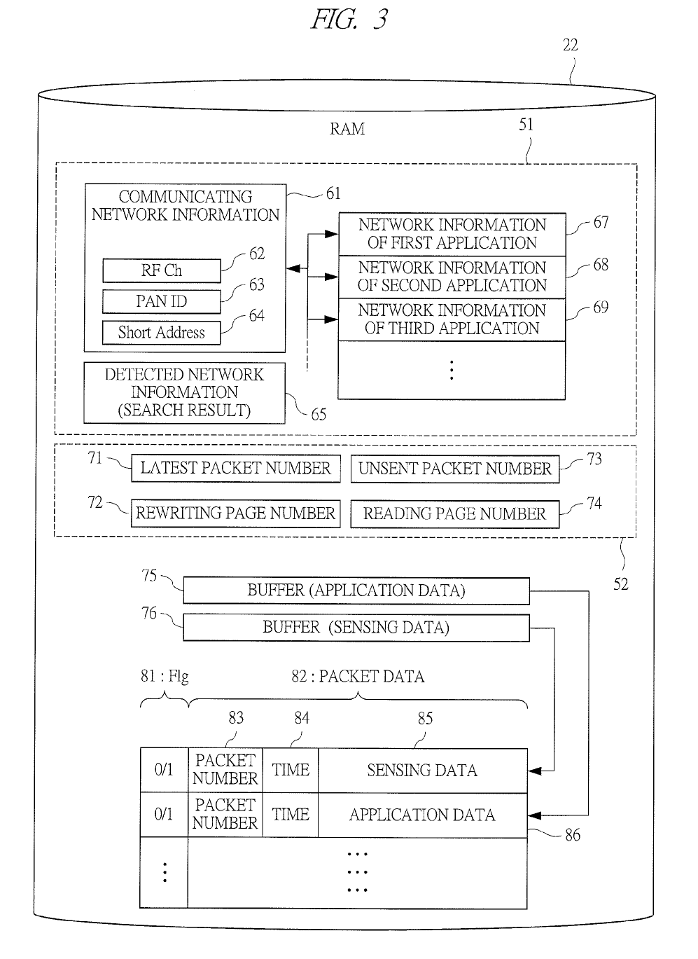

FIG. 3 shows a configuration of the data recorded in the RAM 22 in the present invention, and in order to solve a problem in the network changes, the configuration is characterized by including network information 67 to 69 for the first to third applications to which network information can be saved.

The RAM 22 includes a parameter 51 of the wireless communication protocol 36, a parameter 52, a buffer 75 to store the sensing data, a buffer 76 to store the data received by the applications 33 and 34, a packet 82 for wireless transmission, and a flag 81 attached to the packet.

In IEEE 802.15.4, the parameter 51 used by the wireless communication protocol 36 is composed of communicating network information 61 including a channel (RFCh) 62 showing a radio frequency, an ID (PAN ID) 63 for identifying a network and the ShortAddress 64 assigned to the sensor node 1, network information 67 to 69 corresponding to the applications 32 to 34, and network information 65 detected when neighboring networks are searched. These are similarly included in other wireless protocols.

The network information 67 to 69 are read from the network information 47 to 49 programmed to the respective applications of the RCM 25 in advance, and can change and save the communicating network information 61. Therefore, the easy network change can be made only to the networks which can communicate with the sensor node 1.

Since the position to record data in the storage 5 is managed by the storage control program 44, the parameter 52 includes a rewriting page number 72 showing a page that is rewritten when data is written in the storage 5 and a latest packet number 71 to be attached to the package to be transmitted. In addition, for the data reading by the retransmission control program 45, the parameter 52 further includes the page number 74 whose retransmission is completed last and a packet number 73 retransmitted last (unsent packet number).

Further, in order to temporarily store the data before the sensing data is set to the form of the packet (or before it is compressed), the output value of the sensor 6 is stored in the buffer 75 by the process of the sensing program 35. The buffer 75 is secured up to the capacity that can be transmitted in one wireless transmission. For example, in IEEE 802.15.4, about 100 bytes of data can be set to a packet, and therefore, the size of the buffer 75 is restricted to this. When the sensing data is set in the buffer 75 up to the almost maximum capacity thereof and the buffer cannot store data any more, the data recorded so far in the buffer 75 is set to the sensing data region 85 of the packet 82, and new sensing data is then overwritten and set to the buffer 75.

In the same manner, the data which the applications 33 and 34 receive are stored in the buffer 76. Since the change is always made to either one of the applications 33 and 34, the buffer 76 is shared by the applications 33 and 34. Therefore, when all the processes of the applications 33 and 34 are completed, the data of the buffer 76 is set in the application data region 86 of the packet 83.

When data is set to the packet 82 from the buffer 75 or the buffer 76, the sensing program 35 acquires the current time data 84 from the real time clock 4 and sets it to the packet 82. Further, it sets the latest packet number 71 of the RAM 22 to the packet number 83 of the packet 82.

By the processing mentioned above, it is possible to know the time when the data is sensed regardless of the timing at which data is transmitted. In addition, whether there is any omission of reception of data can be confirmed later from the packet number 83.

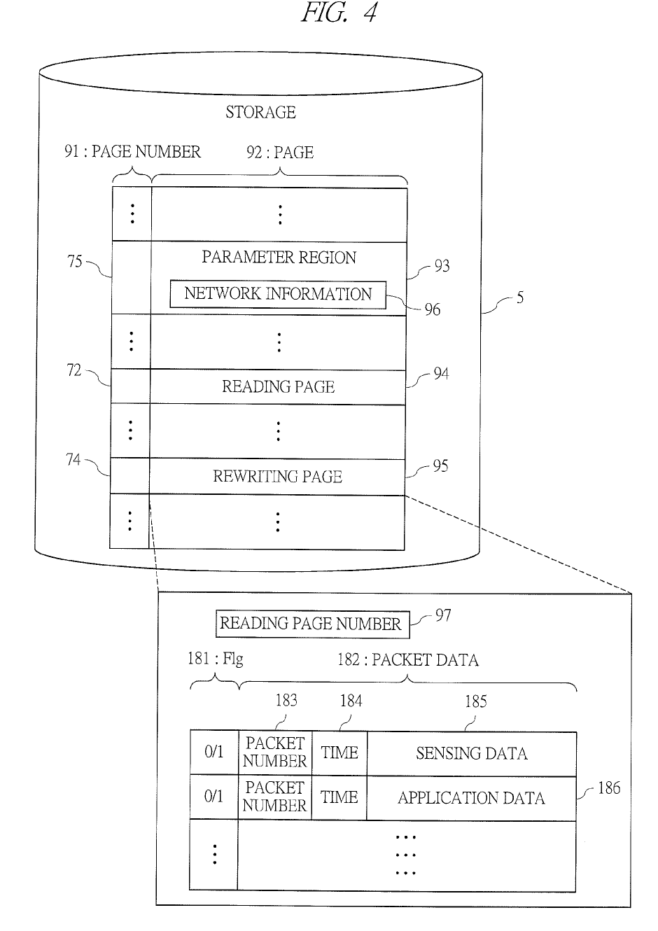

FIG. 4 shows the configuration of data recorded in the storage 5. In order to solve the first and second problems, it is characterized in that only the unsent data can be immediately read out from the sensing data and the data of the applications recorded in the storage 5 by the use of the flag 181, the reading page number 72 and the rewriting page number 74. Details thereof will be described below.

In the page 92 serving as a unit of rewriting in the storage 5, the page number 91 is sequentially assigned to each page 92 from 0. In the page 92, a flag 181 and a packet 182 that are the flag 81 and the packet 82 transferred from the RAM 22 and a reading page number 94 are recorded. The reading page number 94 shows the reading page number 74 that is present in the RAM 22 at the time when the page 92 is rewritten.

The data transferred from the RAM 22 or others rewrites the page 94 shown by the rewriting page number 74. In addition, in order to start the reading from an unsent packet, the page 94 shown by the reading page number 72 is read.

On the other hand, the parameter 52 of the storage control program 44 in the RAM 22 is deleted due to battery exhaustion and reset in some cases. In order to solve this problem, the procedure to restore the parameter 52 is shown below.

At the time of activation, only the packet numbers 183 are all read, and the previous page 92 of the page where the packet numbers 183 become discontinuous is determined as the page 92 rewritten last. Therefore, a value obtained by adding 1 to the page number 92 of the page rewritten last (0 when exceeding the maximum number of pages) is restored to the rewriting page number 72 of the RAM 22. Next, a value obtained by adding 1 to the previous packet number of the packet number where the packet numbers become discontinuous (0 when exceeding the maximum value) can be restored as the latest packet number 71 of the RAM 22.

Next, the reading page number 94 recorded in this page 92 rewritten last is read. This value is determined as the reading page number 74 present in the RAM 22 just before the deletion, and this value is restored in the RAM 22. Next, the flag 181 in the page shown by the reading page number 74 is read, and the packet number 83 of the oldest packet 82 whose flag 181 is 1 is read, and a value from which 1 is subtracted (maximum value when the value becomes 0 or less) can be restored as the unsent packet number 73 of the RAM 22.

By the process described above, even if the data of the RAM 22 is deleted, the parameter 52 can be restored just by reading the data recorded in the storage 5.

Similarly, in order to restore the network information 67 to 69 to their original state at the time of battery exhaustion and reset, a parameter region to record the parameter of the RAM 22 is secured in one of the pages 92 of the storage. For example, the network information 93 to 96 which is the same as the network information 67 to 69 recorded in the RAM 22 can be backed up.

FIG. 5 shows the details of the step 101 of FIG. 2, and the process flow of the sensing program 35 is described with a flow chart. This flow chart is characterized in that the maximum sensing data is set to the packet by utilizing the buffer 75.

At step 201, the output value of the sensor 6 is A/D converted by the A/D converter 24, and the sensing data which is the converted value is set to the buffer 75 of the RAM 22. The sensing data set to the buffer 75 can be compressed by the process of the compression program 46 at step 202. When the sensing data set to the buffer 75 exceeds the capacity of the buffer 75, the procedure goes from the step 203 to the step 204, and the sensing data of the buffer 75 is set to the packet 82. Also, when it does not exceed the capacity, the procedure goes to step 207, and the process is completed in the state where the data is left in the buffer 75.

As a result of the process above, the data volume in each transmission is maximized to reduce the number of transmissions and the time when the wireless communication unit 7 is activated is shortened. By this means, the power consumption can be reduced.

Further, FIG. 6 shows the details of the step 120 of FIG. 2, and the process flow of the application 32 is described with a flow chart. In this flow chart, the sensing data made by the process of FIG. 14 is transmitted (step 502). Thereafter, the retransmission control program 45 is called, and the flag 81 of the packet is set to 0 at the time when the transmission succeeds (step 504). Further, the unsent data recorded in the storage 5 is retransmitted on the same network (step 505). In addition, at the time when the transmission fails, the flag 81 of the packet is set to 1 (step 511). Other processes will be individually described below.

At step 503, the transmission result of step 502 is determined from the presence or absence of Ack. If Ack is present, it is determined as a success, and the procedure goes to step 504, and if Ack is not present, it is determined as a failure, and the procedure goes to step 511. At step 506, the process of the application 32 is completed and the procedure returns to the step 120.

As a result of the process above, by transmitting the unsent data of the storage 5 on the same network as the transmission of the sensing data, data can be collected en bloc in a monitor PC.

FIG. 7 shows the step 103 of FIG. 2 in detail, and the process flow of the applications 33 and 34 is described with a flow chart. In this flow chart, it is characterized in that, in order to change the applications correspondingly to the networks in the place, the change of the network information recorded in the RAM 22 (step 413) and the change of the application in accordance with the selected network (step 422) are processed in combination. Other processes will be individually described below.

Since each application restarts the process after sensing even when the process is stopped by the occurrence of interrupt during the process, the progress of the processing is retained to pass unnecessary processes at steps 401, 402 and 410. At step 401, if the communicating network is changed to the networks corresponding to the applications 32 and 33 after an interrupt by the button 3 just before, the process of network change is passed, and the procedure goes to step 402. If it is not changed, the procedure goes to step 410 and the process of the network change is started. At step 410, further, if the network search is completed or unnecessary, the step is passed and the procedure goes to step 411. If it is not completed, the procedure goes to step 420 and the network search is started. In addition, at the step 402, if the RF transmission/reception intrinsic to the applications 33 and 34 is already completed after the network change, the step is passed and the procedure goes to step 403. If it is not completed, the procedure goes to step 422.

At step 411 to step 421, the flow of the network change process that is a characteristic of the present invention is shown with a flow chart.

At step 420, a network in the place is searched by the wireless communication protocol 36, and the result is set to neighboring network information 65 of the RAM 22. If there is at least one network which can communicate in the set neighboring network information 65, the procedure goes from step 411 to step 412, and if there is no such network, the procedure goes to step 405 and the process of the application is completed. At the step 412, if there are a plurality of networks which can communicate in the neighboring network information 65, the procedure goes to step 421, and a network corresponding to the application selected by the button operation of the user is selected.

When the network to be changed is selected, at step 413, the communicating network information 61 is saved in the network information 67 to 69 of the RAM 22, and the network information selected at step 421 is set to the communicating network information 61, thereby changing the networks.

Furthermore, at step 403, on the contrary to the process of the step 413, the network information before the change is returned to the communicating network information 61, and after returning to the original network, the process of the application is completed.

By the processes above, the change to necessary applications on the spot can be achieved by a minimum operation.

FIG. 8 shows an example of a concrete operation by a user when the data measured by the scales is received by the application 33. The measured weight data is displayed on the LCD 8 of the sensor node 1 so that the user 300 can check it. When the user 300 wants to record this displayed result in the storage 8, the user pushes the button 3 corresponding to “OK”. When the “OK” is selected, the application 33 records the weight data in the storage 8 and completes the process. Also, when the user does not want to record the data, the user pushes the button 3 corresponding to “Cancel”. When the “Cancel” is selected, the application 33 deletes the received weight data and completes the process.

By the process mentioned above, the user 300 can select whether to record data on the spot before collecting it in the monitor PC. Therefore, even when error data is transmitted due to the malfunction of the scales or the wireless communication unit, the user can remove it.

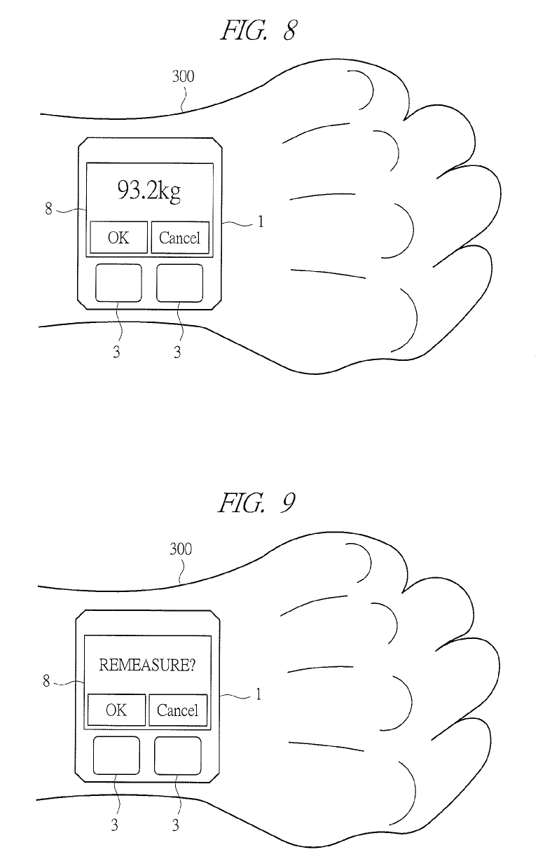

In addition, FIG. 9 shows an example of the operation that the user 300 selects whether to measure the weight again by the process of the application 33. For example, when the user 300 does not record the weight data in FIG. 8, the user can measure it again. When the “OK” is selected, the process of the application 33 is not completed and the process of receiving the weight data is carried out repeatedly. For example, since several seconds are typically necessary for the measurement of the weight, the reception process is carried out 10 seconds later. When the “Cancel” is selected, the process of the application 33 is completed.

By the process mentioned above, the process of the application can be continued until the user can receive appropriate data. Therefore, since it is not necessary to change the applications every time even when the measurement is carried out repeatedly, the processes of the microcomputer 2 can be reduced, and thus the power consumption can be reduced.

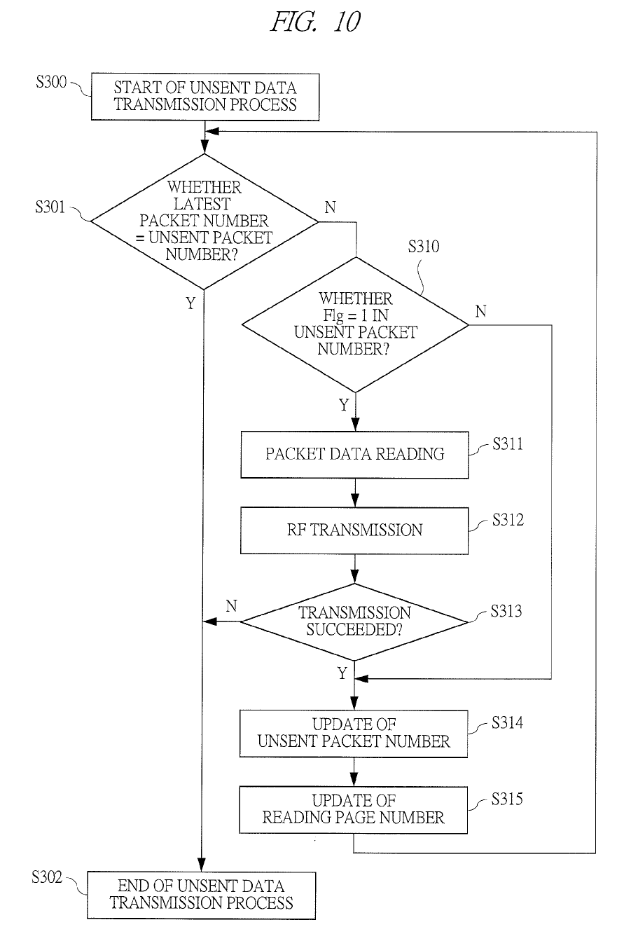

FIG. 10 shows the step 505 of FIG. 6 in detail, and the process flow of the retransmission control program 45 is described with a flow chart. In particular, it is characterized in that, in order to read only unsent data from the storage 5 immediately, a step 301 to determine whether unsent data is present in the storage 5 (or RAM 22) and a step 310 to determine whether the packet 182 at the reading position of the storage 5 is unsent data by the flag 181 are processed in combination.

First, the latest page number 71 and the unsent packet number 73 are compared (step 301), and when they are different, the flags 81 and 181 shown by the unsent packet number 73 are read from the RAM 22 or the storage 5 (step 310).

If the flags 81 and 181 are 1, the corresponding packets 82 and 182 are read (step 311) and are transmitted (step 312). If the transmission at the step 312 succeeds, the unsent packet number 73 is updated by adding 1 thereto (step 314). However, when the packet number reaches the maximum, it is set to 0. When data in the page that is read here are all transmitted, the reading page number is also updated by adding 1 thereto (step 315). However, when the reading page number reaches the maximum, it is set to 0.

In addition, when the flags 81 and 181 are 0 at the step 310, the corresponding packets 82 and 182 are not transmitted, and the procedure goes to the update process of unsent packet number (step 314).

These processes are repeated until the latest page number 71 and the unsent data package number 72 become the same at step 301 or the transmission fails at step 313. In addition, when an interrupt occurs, the above processing is completed.

As a result of the process above, it is possible to efficiently read only the unsent data from the storage 5, and in an environmental in which wireless communication is available with the gateway connected to a monitor PC, it is possible to consecutively transmit the read data.

FIG. 11 shows the step 104 of FIG. 2 in detail, and the process flow of the storage control program 44 is described with a flow chart. In particular, it is characterized in that, in order to minimize the number of rewrites of the storage 5, the accumulation of the data for one page in the RAM 22 is determined at the step 601, and the data is transferred to the storage in the state where the data for one page is accumulated, and then the rewriting process is performed (step 602).

Further, after the rewriting, the rewrite page number 72 is updated by adding 1 thereto at step 603. However, when the number exceeds the maximum number of pages, it is set to 0.

As a result of the process above, the power necessary for rewriting of the storage 5 can be reduced, and further, since the numbers of rewrites to the respective pages are averaged, it is possible to maximize the rewrite life of the storage 5.

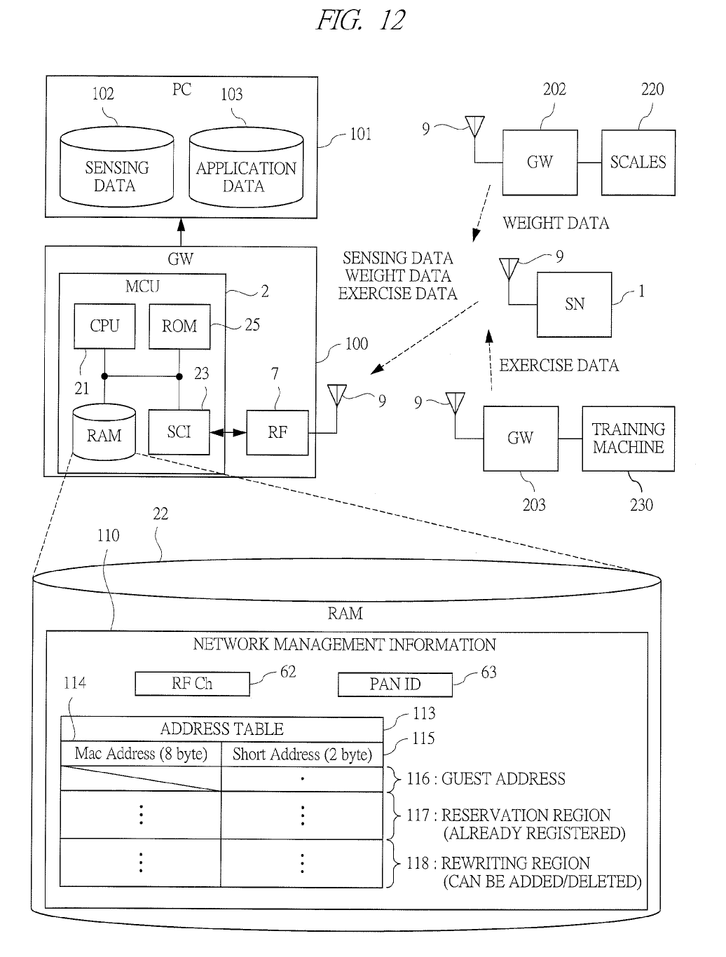

FIG. 12 shows the configuration of the sensor net system according to the present invention. In particular, it is characterized in that, in order to make it possible to determine the MacAddress 31 of the sensor node 1 in the gateway 100 by the packet received from the sensor node 1 that communicates by changing networks, an address table 113 includes a reservation region 117 to which the correspondence with the ShortAddress 64 is assigned and a guest address 116 that can be used by indefinite node. Details thereof will be described below.

For example, the sensor net system is composed of the sensor node 1, the gateway 100 connected to a PC 101, and gateways 202 and 203 connected to the scales 220, the training machine 230 and others.

The gateway 100 includes the wireless communication unit 7 and the microcomputer 2. The microcomputer 2 includes the CPU 21, the ROM 25, the RAM 22 and the serial communication interface 23. In the RAM 22, the information of the networks managed by the gateway 100 (network management information) 110 is recorded.

Network management information 110 is composed of an RFCh 62, a PAN ID 63, and an address table 113. The address table 113 shows the correspondence of the MacAddress 31 and the ShortAddress 64 in the network.

In the gateway 100, the MacAddress 31 is known by the address table 113 from the ShortAddress 64 of the received packet, and the sensor node 1 of the transmission source can be identified. The address table 113 has generally a rewritable region 118, and in the definition of IEEE 802.15.4, the address table 113 is created by transmitting and assigning the ShortAddress 64 that is not assigned to the sensor node 1 as a response of the access request when an association request including the MacAddress 31 from the sensor node 1 is received. In addition, in the case where a disassociation request is received, the ShortAddress 64 of the transmission source is deleted from the address table 113.

On the other hand, in the characteristic reservation region 117, the assignment can be decided in advance by the operation from the PC 101, and no rewriting is performed.

Further, since the gateway 100 receives a packet from an indefinite sensor node 1 that does not register the MacAddress 31 to the address table 113, the sensor node 1 can use the guest address 116.

The details of the sensor net system illustrated in FIG. 12 will be described below.

The sensor node 1 usually transmits the packet to which the sensing data is set by the process of the application 32 at a fixed interval (for example, once per second). Also, when the transmission succeeds and the unsent data is present in the storage 5 and the RAM 22 of the sensor node 1, the unsent data is transmitted next, and the transmission is repeated until the unsent data disappears or the transmission fails.

The packet of the sensing data transmitted from the sensor node 1 is received by the gateway 100, and it is transferred to the PC 101. The sensing data 185 and the time 184 set to the packet 182 are recorded to a storage (for example, hard disks) 102 in the PC. All sensing data transmitted from the sensor node are rearranged in chronological order by the time 184 set to the same packet 182. Therefore, when the unsent data disappears in the sensor node 1, all the continuous sensing data obtained by the sensing of the sensor node 1 are recorded in the PC 101.

Further, the sensor node 1 can receive the weight data measured by the scales 220 and the exercise data which are the results of exercises with the training machine 230 by the communications of various applications 33 and 34.

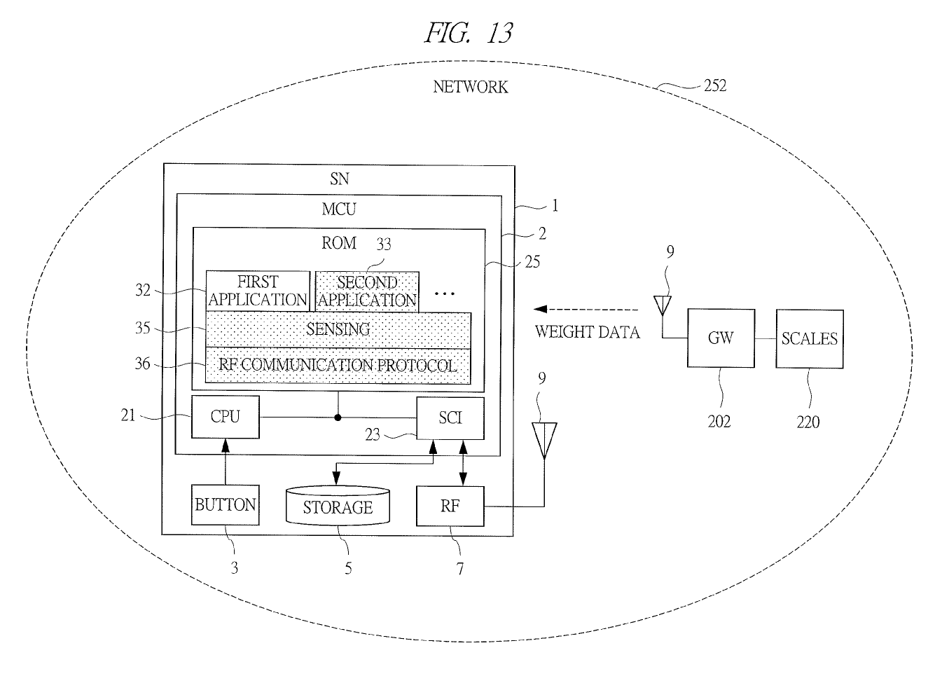

Therefore, FIG. 13 and FIG. 14 show means to solve the first and second problems in the sensor net system shown in FIG. 12.

FIG. 13 concretely shows the characteristic procedure in this means, in which applications are changed in conformity to the networks in the place, and the data of the application and the sensing data in that period are recorded in the storage without fail. For example, the sensor node 1 is in a condition where it has been moved to the place near the scales 220 and the gateway 202 apart from the network 150 at home. At first, when the user 300 searches for a network by pushing the button 3, the network 252 is detected. For example, when the network information of this network 252 is the same as the network information 68 of the second application in the RAM 22, the communicating network information 61 is saved to the network information 67 of the first application, and is changed to the network information 68 of the second application. More specifically, the network 252 becomes the communicating network.

After the change of networks, the process of the application 33 corresponding to this network 252 is started. The application 33 communicates with the pro gateway 202 and receives the weight data measured with the scales 220. The received weight data are stored in the RAM 22 and then recorded to the storage 5. When the process of the application 33 is completed, the network information 67 of the first application is set to the communicating network information 61, and the network returns to the original network 150.

Further, FIG. 14 concretely shows the characteristic procedure in this means, in which the unsent data is read from data recorded in the storage 5 and collected by the monitor PC 101.

When the sensor node 1 moves into the original network 150, the sensor node 1 transmits the unsent packet recorded in the RAM 22 and the storage 5 to the gateway 100 by the process of the application 32 and the wireless communication protocol 36. This data includes the data sensed during the network change shown in FIG. 13 and the data of the applications 33 and 34 (for example, the received weight data).

Therefore, the received weight data and sensing data are transmitted to the predetermined monitor PC 101 from the gateway 100 and can be recorded to the storages 102 and 103, respectively.

By the processes mentioned above, for example, when the user 300 with the sensor node 1 goes out from home and measures the weight in the place outside home, the user 300 can receive weight data just by the simple operation of button push and can collect it in the monitor PC 101 at the time when returning back to home automatically without any other operation. Further, these processes can be realized with the processing time and power consumption similar to those of the case where no network change is performed. Furthermore, the sensing data while away from home including such an application change can be completely collected. Since all the data mentioned above are recorded in the storage 5, there are various utilizations other than the transmission to the monitor PC 101. For example, the data in the storage 5 can be displayed and viewed on the LCD 8 of the sensor node 1, and the data recorded to other machine can be transmitted at a place without the monitor PC 101.

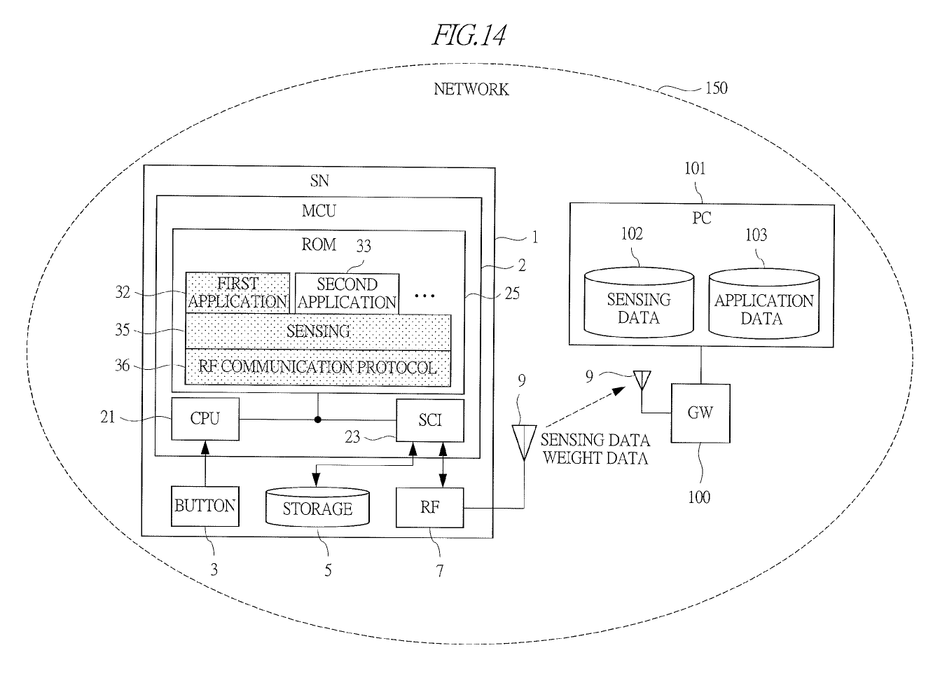

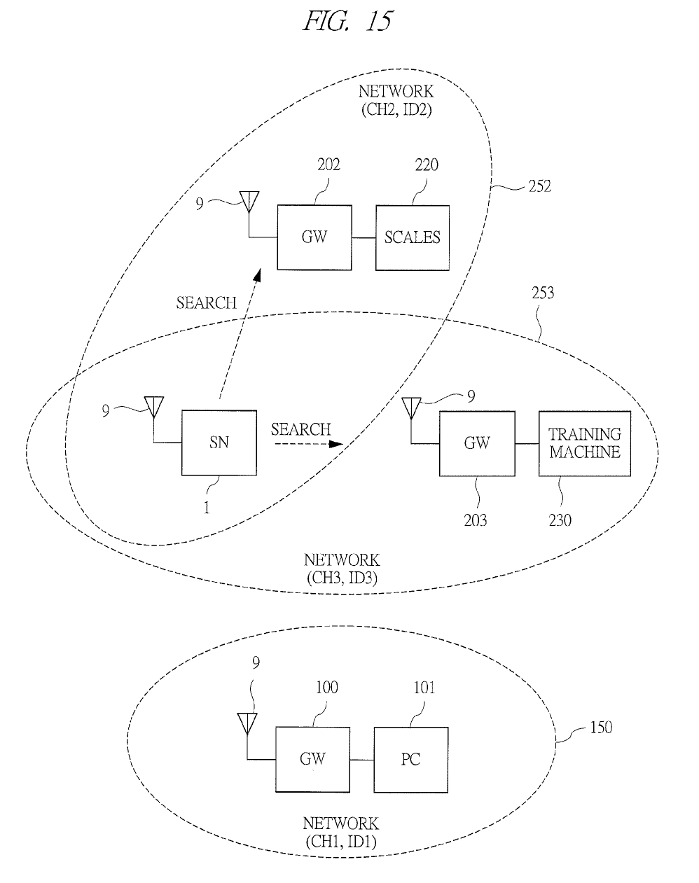

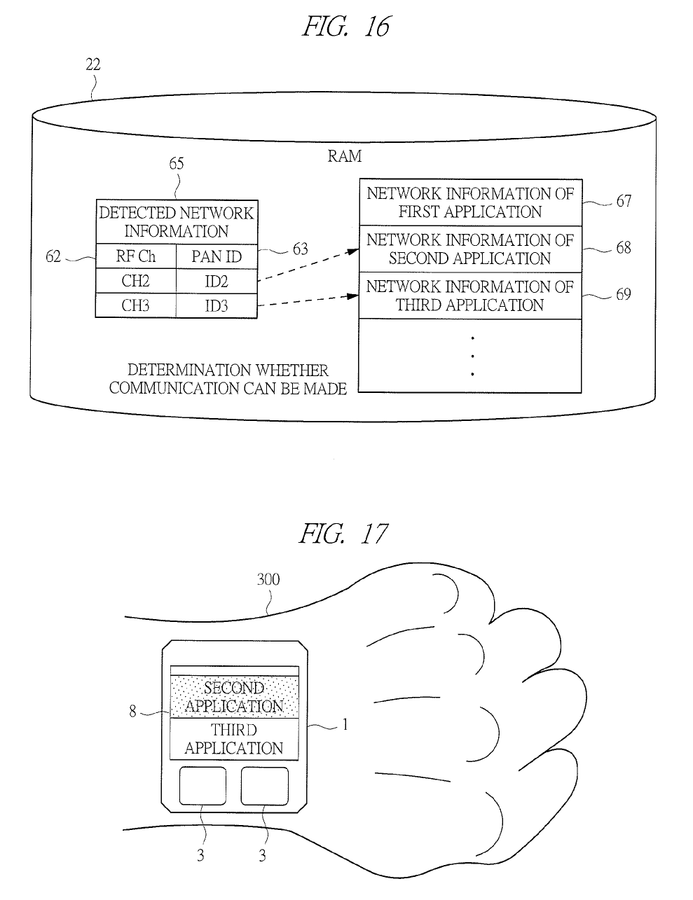

FIG. 15, FIG. 16 and FIG. 17 show characteristic means in which the user selects an appropriate application when there are a plurality of networks 252 and 253 around the sensor node 1.

FIG. 15 shows the state where there are a plurality of gateways 202 and 203 around the sensor node 1. Therefore, when the sensor node 1 searches for networks, the plurality of networks 252 and 253 are detected.

Next, FIG. 16 shows the data set to the RAM 22 of the sensor node 1. The wireless channel 62 (RFCh) of the network detected by the process of the wireless communication protocol 36 and the ID of the network (PAN ID) 63 are set to the detected network information 65. The set detected network information 65 and the network information 67 to 69 of the applications set in the RAM 22 are compared and it is determined whether they are matched (whether they can communicate).

Furthermore, FIG. 17 shows the means that the user selects one application from a plurality of applications. In FIG. 17, the names of the applications 33 and 34 corresponding to the networks 252 and 253 are displayed on the LCD 8 of the sensor node 1, and the user 300 can select and decide one application by the operation of the button 3 of the sensor node 1. When the application 33 is selected by the decision of the user 300, the procedure shifts to the same state as FIG. 13.

By the processes above, the user can easily select the application that the user wants to use on the spot even in the environment where a plurality of applications are available.

FIG. 18 shows an example of the function of the application 33, and it is characterized in that history data can be displayed on the LCD 8 of the sensor node 1 in order to check the data recorded in the storage 5 in a place without the monitor PC 101. This can be activated by the user 300 operating the button 3, and the weight data measured with the scales 220 and received from the gateway 202 can be read from the storage 5 and the past weight history can be displayed on the LCD 8 together with the date and time.

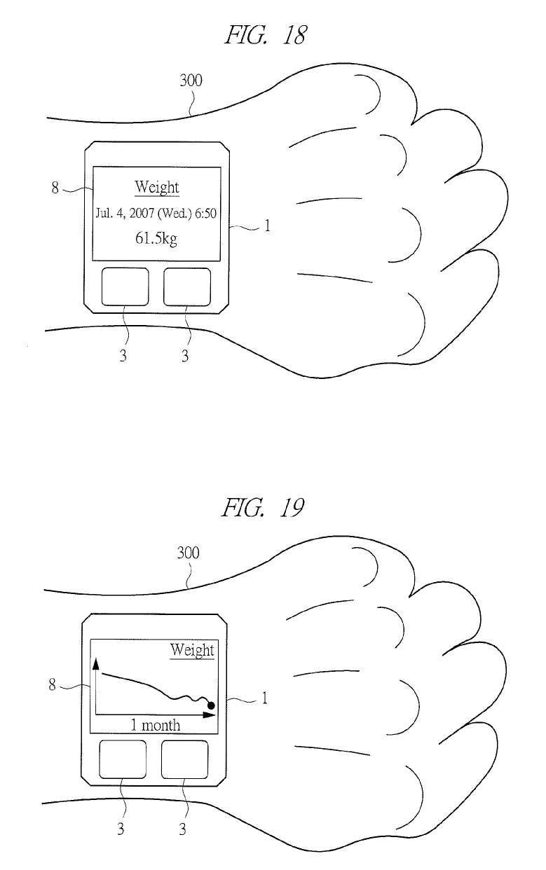

Furthermore, FIG. 19 is characterized in that a graph is displayed to check the long-term change of weight data of FIG. 18. Similar to FIG. 18, the weight history read from the storage 5 can be sorted based on the date and time, and the change of the weight value can be displayed in a graph on the LCD 8.

According to the above-described embodiments of the present invention, even when the user with the sensor node moves and communicates with a plurality of wireless devices while changing the networks, the user can collect all data en bloc by a specified monitor PC by collectively transmitting the data recorded in the storage after returning to the original network (network to which the data of the sensor is transmitted).

Moreover, even when applications to be processed are changed with the change of the networks, the continued data of the sensor can be surely collected by the monitor PC without fail.

What is claimed is:

1. A sensor node having a sensor for measuring biological information and a wireless communication unit for transmitting data, the sensor node further comprising:
a plurality of intrinsic programs that drive the wireless communication unit to communicate with different wireless devices;
a common program that drives the sensor to make a measurement without being dependent on the intrinsic programs; and
a nonvolatile memory unit that records the data.

2. The sensor node according to claim 1,
wherein network information that is necessary to drive the wireless communication unit when making communication with respectively corresponding wireless devices is individually provided for the intrinsic programs.

3. The sensor node according to claim 1,
wherein, when wireless devices with which communication is made are changed, network information prepared in the intrinsic programs is changed to control the wireless communication unit.

4. The sensor node according to claim 1,
wherein the intrinsic programs are changed and processed in accordance with wireless devices with which communication is made.

5. The sensor node according to claim 1,
wherein data obtained by the communication of the intrinsic programs and data measured by the sensor are all recorded in the nonvolatile memory unit.

6. The sensor node according to claim 1,
wherein, when the data are recorded, the data are managed by attaching a flag to distinguish whether or not the data has been already sent to a wireless device to which a transmission is needed, the flag being attached for each packet that is a unit of transmission.

7. The sensor node according to claim 1,
wherein, when communications can be made with a specified wireless device for collecting the data, the data are read and transmitted from the nonvolatile memory unit.

8. The sensor node according to claim 1,
wherein, when data are read from the nonvolatile memory unit, only a flag is first read and then only unsent data are determined and read.

9. The sensor node according to claim 1,
wherein an intermittent operation in which process is started by an interrupt of a real time clock and is stopped in a spare time is performed.

10. The sensor node according to claim 1,
wherein a process of the intrinsic programs is temporarily stopped by an interrupt of a real time clock, and the sensor is driven by the common program to take in the data.

11. The sensor node according to claim 1,
wherein the network information and the intrinsic programs are changed with a button as a trigger.

12. A sensor network system including a sensor node and a base station configured to be wirelessly communicable with the sensor node,
wherein the sensor node has a sensor for measuring biological information and a wireless communication unit for transmitting data, and
the sensor node further comprises:
a plurality of intrinsic programs that drive the wireless communication unit to communicate with different wireless devices;
a common program that drives the sensor to make a measurement without being dependent on the intrinsic programs; and
a nonvolatile memory unit that records the data.

13. The sensor network system according to claim 12,
wherein network information that is necessary to drive the wireless communication unit when making communication with respectively corresponding wireless devices is individually provided for the intrinsic programs.

14. The sensor network system according to claim 12,
wherein, when wireless devices with which communication is made are changed, network information prepared in the intrinsic programs is changed to control the wireless communication unit.

15. The sensor network system according to claim 12,
wherein the intrinsic programs are changed and processed in accordance with wireless devices with which communication is made.

16. The sensor network system according to claim 12,
wherein data obtained by the communication of the intrinsic programs and data measured by the sensor are all recorded in the nonvolatile memory unit.

17. The sensor network system according to claim 12,
wherein, when the data are recorded, the data are managed by attaching a flag to distinguish whether or not the data has been already sent to a wireless device to which a transmission is needed, the flag being attached for each packet that is a unit of transmission.

18. The sensor network system according to claim 12,
wherein, when communications can be made with a specified wireless device for collecting the data, the data are read and transmitted from the nonvolatile memory unit.

19. The sensor network system according to claim 12,
wherein, when data are read from the nonvolatile memory unit, only a flag is first read and then only unsent data are determined and read.

20. The sensor network system according to claim 12,
wherein an intermittent operation in which process is started by an interrupt of a real time clock and is stopped in a spare time is performed.
